(19) United States
(12) Patent Application Publication
(10) Pub. No.: US 2021/0263812 A1
(43) Pub. Date: Aug. 26, 2021

(54) CROSS-PROTOCOL CONTROL APPARATUS WITH APPARATUS-RESTORING FUNCTION AND CROSS-PROTOCOL METHOD FOR RESTORING APPARATUSES

(71) Applicant: Delta Electronics, Inc., Taoyuan City (TW)

(72) Inventor: Pei-Chen LU, Taoyuan City (TW)

(21) Appl. No.: 17/170,443

(22) Filed: Feb. 8, 2021

(30) Foreign Application Priority Data
Feb. 19, 2020 (CN) 202010101736.3

(51) Int. Cl. G06F 11/14

(52) U.S. Cl. CPC G06F 11/1469; G06F 11/1464; G06F 11/1451

(57) ABSTRACT

A cross-protocol control apparatus with apparatus-restoring function and cross-protocol method for restoring apparatuses are provided. The apparatus is connected to a management apparatus and the electronic apparatuses by the communication interfaces based on the different communication protocols. When the reception of a restoring command for any electronic apparatus from the management apparatus, the apparatus executes a restoring procedure. During the execution of restoring procedure, the apparatus recognizes the corresponding communication interface, retrieves backup data of the corresponding electronic apparatus, transforms the backup data into restoring data compatible with the communication protocol supported by the communication interface, and transfers the restoring data to the electronic apparatus for making the electronic apparatus restore the configurations based on the restoring data. The present disclosed example can restore the electronic apparatuses compatible with the different communication protocols by the management apparatus based on the existing communication protocol.

### BACKGROUND OF THE INVENTION

### Field of the Invention

The technical field of the present disclosed example relates to a restore apparatus, and more particularly related to a cross-protocol control apparatus with apparatus-restoring function and a cross-protocol method for restoring apparatuses.

### Description of Related Art

Currently, many communication protocols have been provided. The electronic apparatuses are usually configured to use the different communication protocols according to the different requests. Above circumstance makes the user have to prepare a management apparatus (such as PC, tablet, laptop, or server, etc.) having the ability to support all of the communication protocols if the user would like to manage and configure a plurality of electronic apparatuses installed in the same environment.

The above circumstance significantly increases the cost of the management apparatus, and significantly limits the computer types qualified as the above management apparatus.

Moreover, when the electronic apparatus is with a problem or its configuration is modified, the administrator can only modify the configuration of the electronic apparatus manually for trying to solve the problem or revert the modification.

The above circumstance causes trouble to the administrator, and wastes manpower and time. Accordingly, there is currently a need for a schema of solving the above-mentioned problems.

### SUMMARY OF THE INVENTION

The present disclosed examples are direct to the cross-protocol control apparatus with apparatus-restoring function and the cross-protocol method for restoring apparatuses having the ability to make the management apparatus use the same communication protocol to connect to a plurality of the electronic apparatuses respectively with different communication interfaces, and automatically revert the configurations of the electronic apparatus.

One of the exemplary embodiments, a cross-protocol method for restoring apparatuses is applied to a cross-protocol control apparatus, the method comprises following steps: a controller of the cross-protocol control apparatus connecting to a management apparatus and a plurality of electronic apparatuses by a plurality of communication interfaces of the cross-protocol control apparatus, wherein the communication interfaces are respectively configured to use a plurality of different communication protocols; executing a restoring procedure when receiving a restoring command for at least one of the electronic apparatuses from the management apparatus; during the restoring procedure, recognizing the communication interface connected to the electronic apparatus and retrieving backup data for the electronic apparatus; during the restoring procedure, executing a process of forwarding-format-transforming on the backup data for transforming the backup data into restoring data compatible with the communication protocol used by the communication interface being recognized; and, during the restoring procedure, transferring the restoring data to the electronic apparatus for making the electronic apparatus restore configurations by itself based on the restoring data.

One of the exemplary embodiments, a cross-protocol control apparatus with apparatus-restoring function comprises a plurality of communication interfaces, a storage, and a controller. The plurality of communication interfaces is respectively connected to a management apparatus and a plurality of electronic apparatuses, the communication interfaces respective use the different communication protocols. A storage is used to store apparatus data of each electronic apparatus.

The controller is electrically connected to the communication interfaces and the storage, the controller is configured to execute a restoring procedure when receiving a restoring command for at least one of the electronic apparatuses from the management apparatus, wherein during the restoring procedure, the communication interface connected to the electronic apparatus is recognized, the backup data of the electronic apparatus is loaded, a process of forwarding-format-transforming is executed on the backup data for transforming the backup data into restoring data compatible with the communication protocol used by the communication interface being recognized, and the restoring data is transferred to the electronic apparatus for making the electronic apparatus restore configurations by itself based on the restoring data.

The present disclosed example can restore the electronic apparatuses compatible with the different communication protocols by the management apparatus based on the existing communication protocol.

### BRIEF DESCRIPTION OF DRAWINGS

The features of the present disclosed example believed to be novel are set forth with particularity in the appended claims. The present disclosed example itself, however, may be best understood by reference to the following detailed description of the present disclosed example, which describes an exemplary embodiment of the present disclosed example, taken in conjunction with the accompanying drawings, in which:

FIG. 1 is a connection architecture diagram of management apparatus and electronic apparatuses of the related art;

FIG. 2 is an architecture diagram of the cross-protocol control apparatus according to one implement aspect of the present disclosed example;

FIG. 3 is an architecture diagram of the cross-protocol control apparatus according to another implement aspect of the present disclosed example;

FIG. 4 is a schematic view of the forwarding format according to an implement aspect of the present disclosed example;

FIG. 5 is a flowchart of the cross-protocol method for restoring apparatuses according to a first embodiment of the present disclosed example;

FIG. 6 is a flowchart of the backup procedure of the cross-protocol method for restoring apparatuses according to a second embodiment of the present disclosed example;

FIG. 7 is a flowchart of the forwarding procedure of the cross-protocol method for restoring apparatuses according to a third embodiment of the present disclosed example;

FIG. 8 is a flowchart of the cross-protocol method for restoring apparatuses according to a fourth embodiment of the present disclosed example; and

FIG. 9 is a flowchart of the process of format-transforming of the cross-protocol method for restoring apparatuses according to a fifth embodiment of the present disclosed example.

### DETAILED DESCRIPTION OF THE INVENTION

In cooperation with attached drawings, the technical contents and detailed description of the present disclosed example are described thereinafter according to a preferable embodiment, being not used to limit its executing scope. Any equivalent variation and modification made according to appended claims is all covered by the claims claimed by the present disclosed example.

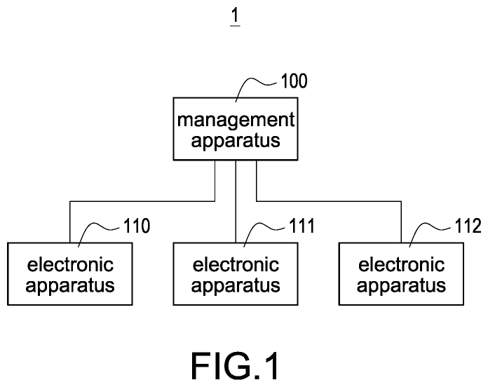

Please refer to FIG. 1 which is a connection architecture diagram of management apparatus and electronic apparatuses of the related art. In this example, a plurality of electronic apparatuses 110-112 arranged in the same environment 1, such as the same factory or the same floor, are respectively configured to use the different communication protocols, such as MODBUS, CANopen and EtherCAT.

If the administrator would like to configure the electronic apparatuses 110-112, by using the single management apparatus 100 to control all of the electronic apparatuses 110-112, the management apparatus 100 supporting the communication protocols respectively used by all of the electronic apparatuses 110-112 is needed. However, the more the communication protocols supported by the management apparatus 100 cause the higher the cost of the management apparatus 100.

Moreover, for connecting to all of the electronic apparatuses 110-112 simultaneously, the management apparatus 100 has to be with a plurality of communication interfaces, such as a plurality of network cards with RJ-45 socket which further increases the cost and the volume of management apparatus 100.

Moreover, it is possible that the environment 1 is maintained by a plurality of administrators, such that when any configuration of any electronic apparatus 110-112 is modified by one of the administrators, the other administrators usually have to manually restore all of the configurations of all of the electronic apparatuses 110-112 to the defaults one by one firstly because the administrator cannot make sure whether the modified configuration will make some error or exception. After restoring, the administrator can manage and control the electronic apparatus 110-112 without worrying about the error and exception. However, the above restoring operations waste a lot of manpower and time.

To solve the above problem, the present disclosed example mainly provides a cross-protocol control apparatus with apparatus-restoring function and a cross-protocol method for restoring apparatuses, the apparatus and method of the present disclosed example can make the management apparatus manage and control the electronic apparatuses using the different communication protocols by single communication interface and single communication protocol. Moreover, the cross-protocol control apparatus can restore the configurations of the electronic apparatuses automatically to omit the user's manual restoring operation.

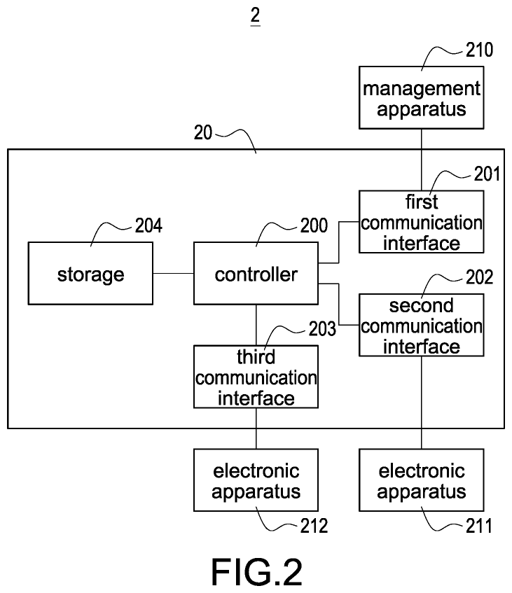

Please refer to FIG. 2 which is an architecture diagram of the cross-protocol control apparatus according to one implement aspect of the present disclosed example. The cross-protocol control apparatus 20 of this implement aspect is arranged in an environment 2 and is a relay forwarding apparatus between the management apparatus 210 and a plurality of electronic apparatuses 211-212.

More specifically, the cross-protocol control apparatus 20 mainly comprises a plurality of communication interfaces (take three communication interfaces respective named the first communication interface 201, the second communication interface 202 and the third communication interface 203 for example in the FIG. 2), a storage 204 and a controller 200 electrically connected to the above devices.

The communication interfaces are used to connected to a plurality of external apparatuses (such as the management apparatus 210 and the electronic apparatuses 211-212) based on the different communication protocols.

One of the implement aspects, the above communication interfaces may be the same type of communication interfaces, but use the different communication protocols. For example, the communication interfaces may be serial communication interface, CAN (Controller Area Network) interface or wired Ethernet interface, and respectively support MODBUS, MODBUS TCP,

CANopen, EthernetCAT, EthernetNet/IP or the other industrial network protocols.

One of the implement aspects, the above communication interfaces may be the different type of communication interfaces, and respectively use the different communication protocols. For example, the communication interfaces may comprise serial communication interface (using the MODBUS protocol), CAN (using the CANopen) interface, wired Ethernet interface (using any

Ethernet protocols), Wi-Fi interface (using the Wi-Fi protocol), Bluetooth interface (using the Bluetooth Protocol), Zigbee interface (using the Zigbee protocol) or the other wired/wireless communication interfaces.

One of the implement aspects, one part of the above communication interfaces may be the same, and another part may be different. And one part of the above communication interfaces may use the same communication protocol, and another part of the above communication interfaces may use the different communication protocols, but this specific example is not intended to limit the scope of the present disclosed example.

The storage 204 is used to save data. The storage 204 may be the built-in storage device, such as hard disk or flash memory, or the interface for external storage, such as socket interface for the memory cards or USB interface. When the storage 204 is the interface for external storage, the storage 204 is used to connect to the external storage devices, such as memory cards, portable flash drive or portable hard drive) for providing the function of external storage.

The controller 200 is used to control the cross-protocol control apparatus 20, and responsible for processing the data to be forwarded and transforming the formats between the communication protocols (described later).

In the example of FIG. 2, the first communication interface 201 is used to connect to the management apparatus 210, the second communication interface 202 and the third communication interface 203 are respectively used to connect the electronic apparatuses 211-212. The first communication interface 201 and the management apparatus uses the same first communication interface, both the second communication interface 202 and the electronic apparatus 211 use the same second communication protocol, and both the third communication interface 203 and the electronic apparatus 212 use the same third communication protocol. At least one of the second communication protocol and the third communication protocol is different from the first communication protocol. Thus, by arranging the cross-protocol control apparatus 20 of the present disclosed example, the management apparatus 210 can be with only single communication interface and single communication protocol, and can communicate with the electronic apparatuses 211-212 respectively using the different communication protocols, so as to effectively reduce the cost and volume of the management apparatus 210.

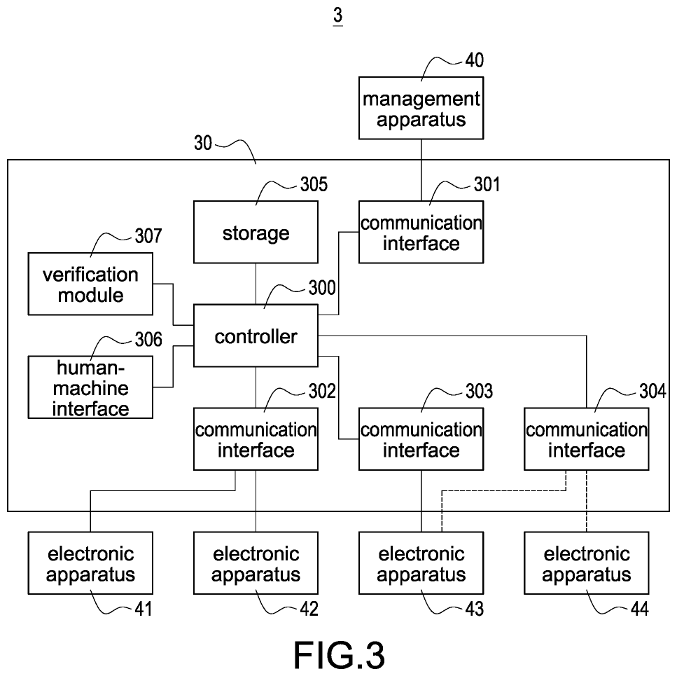

Please refer to FIG. 3, which is an architecture diagram of the cross-protocol control apparatus according to another implement aspect of the present disclosed example. One implement aspect, there are a plurality of electronic apparatuses 41-44 arranged in the environment 3, the cross-protocol control apparatus 30 is used to connect to these electronic apparatuses 41-44 and the management apparatus 40 for providing the management apparatus 40 to manage and control these electronic apparatuses 41-44.

The cross-protocol control apparatus 30 of this implement aspect comprises a plurality of communication interfaces 301-304, a storage 305, a human-machine interface 306, a verification module 307 and a controller 300 electrically connected to above devices.

The communication interfaces 301-304 are respectively connected to the management apparatus 40 and the electronic apparatuses 41-44. The communication interfaces 301-304, the storage 305 and the controller 300 are the same as/similar to the three communication interfaces, the storage 204 and the controller 200 shown in FIG. 2, the relevant description is omitted for brevity.

One of the implement aspects, the communication interface 302 may connect to the electronic apparatuses 41-42 simultaneously, such as two connection sockets on the communication interface 302. Thus, the communication interfaces using the same connection socket type may be integrated into the single communication interface 302, so as to make the administrator be easy to manage and reduce the volume of the cross-protocol control apparatus 30.

One of the implement aspects, the same electronic apparatus 43 may simultaneously connect to the communication interfaces 303-304. For example, the communication interface 303 is wired Ethernet interface and the communication interface 304 is Wi-Fi interface, the electronic apparatus 43 may connect to the communication interface 303 by an Ethernet cable, and connected to the communication interface 304 by Wi-Fi network. Thus, the electronic apparatus 43 may communicate with the cross-protocol control apparatus 30 by a plurality of connections simultaneously, so as to improve the communication quality. For example, one of the connections is as a backup, or all of the connections are simultaneously used for sharing and balancing the loading.

The human-machine interface 306 is used to receive the input operation from the user and output the information. The human-machine interface may comprise any combination of various input devices and output devices, such as the touchscreen, keypad, mouse, display, indicator, speaker and so forth, but this specific example is not intended to limit the scope of the present disclosed example.

The verification module 307 is used for verification, such as verifying the user identity, the authority of the management apparatus 40 or the authority of the electronic apparatuses 41-44.

One of the implement aspects, the verification module 307 may be a verification software and stored in the storage 305. A verification function can be implemented after the controller 300 executes the verification module 307.

One of the implement aspects, the verification module 307 can be a verification chip (such as Google Titan M chip or biometric verification chip) or a verification device (such as the token, fingerprint identification device, RFID verification device and so forth) independent of the controller 300.

One of the implement aspects, the storage 204 shown in FIG. 2 and the storage 305 shown in FIG. 3 may comprise a non-transient computer-readable recording media storing a computer program, the above computer program records a plurality of computer-readable codes. In the implement aspects shown in FIG. 3, when the controller 300 executes the above computer program, the controller 300 can make the cross-protocol control apparatus 30 be the relay forwarding apparatus between the management apparatus 40 and the electronic apparatuses 41-44 to interact with the management apparatus 40 and the electronic apparatuses 41-44, and implement the methods of the embodiments of the present disclosed example.

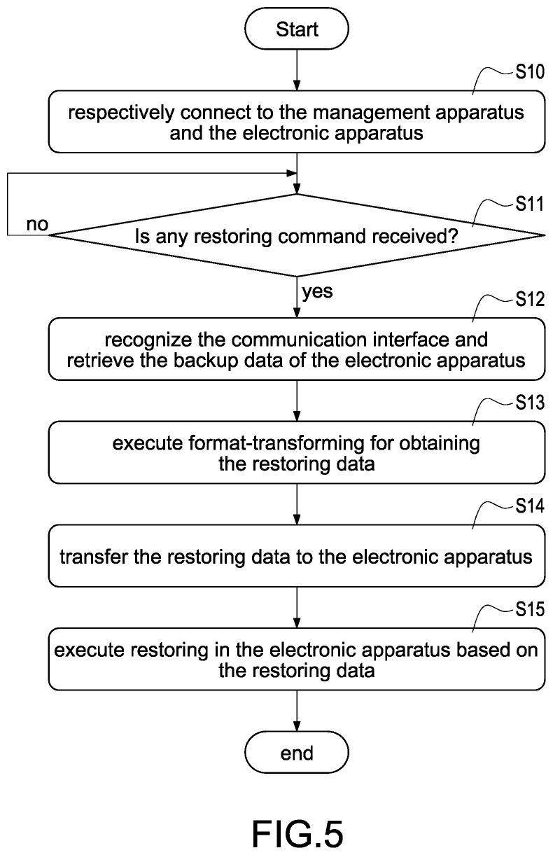

Please refer to FIG. 5, which is a flowchart of the cross-protocol method for restoring apparatuses according to a first embodiment of the present disclosed example. A cross-protocol method for restoring apparatuses is provided by the present disclosed example having the ability to revert the configurations of the electronic apparatuses 41-44 based on the different communication protocols automatically. The method of each embodiment of the present disclosed example may be applied to the cross-protocol control apparatus 20 shown in FIG. 2 or the cross-protocol control apparatus 30 shown in FIG. 3, but this specific example is not intended to limit the scope of the present disclosed example. In the following description, the present disclosed example takes the cross-protocol control apparatus 30 shown in FIG. 3 for explanation. The cross-protocol method for restoring apparatuses of this embodiment comprises following steps.

Step S10: the user firstly makes the communication interfaces 301-304 of the cross-protocol control apparatus 30 respectively connect to the management apparatus 40 and the electronic apparatuses 41-44. Then, the controller 300 establishes the connections with management apparatus 40 and the electronic apparatuses 41-44 respectively by the communication interfaces 301-304. Furthermore, the controller 300 is configured to use the different communication protocols (namely, the communication protocols used by each communication interface 301-304) to communicate with the management apparatus 40 and the electronic apparatuses 41-44.

Step S11: the controller 300 switches to a restoring mode. Under the restoring mode, the controller 300 may determine whether a restoring command is received from the management apparatus 40. The above restoring command is to request to revert at least one configuration of at least one of the electronic apparatuses 41-44 (such as the electronic apparatus 41). If the controller 300 receives the restoring command, the steps S12-S15 are performed for executing a restoring procedure on the electronic apparatus 41. Otherwise, the controller 300 performs the step S11 again for continuously monitoring.

Step S12: during the restoring procedure, the controller 300 recognizes the communication interface 302 connected to the electronic apparatus 41, and retrieves the backup data of the electronic apparatus 41.

One of the exemplary embodiments, the storage 305 stores the backup data of each of the electronic apparatuses 41-44 in advance, and the controller 300 loads the backup data of the electronic apparatus 41 (namely, the electronic apparatus designated by the restoring command) from the storage 305. One of the exemplary embodiments, the backup data of each electronic apparatus 41-44 are stored outside (such as the management apparatus 40 or a cloud storage space), and the controller 300 sends a request to outside for requesting the backup data of the electronic apparatus 41.

Furthermore, the management apparatus 40 may simultaneously transfer the restoring command and the corresponding backup data to the cross-protocol control apparatus 30, but this specific example is not intended to limit the scope of the present disclosed example.

One of the exemplary embodiments, the restoring command comprises identification data (such as MAC address, network address or apparatus alias and so forth) of the electronic apparatus 41, and the controller 300 may recognize the communication interface 302 connected to the electronic apparatus 41 based on the identification data. Step S13: during the restoring procedure, the controller 300 executes a process of forwarding-format-transforming on the backup data for transforming the retrieved backup data into the restoring data. A format of the above restoring data is matched with the forwarding format of the communication protocol used by the recognized communication interface 302.

Step S14: during the execution of the restoring procedure, the controller 300 uses the corresponding communication protocol to transfer the restoring data to the electronic apparatus 41 by the communication interface 302.

Step S14: the electronic apparatus 41 executes the restoring based on the restoring data after receiving the restoring data.

One of the exemplary embodiments, the restoring data comprises the default values of a plurality of operational parameters (apparatus data). The electronic apparatus 41 is controlled to replace the current configuration values of the operational parameters with the default values to complete the restoring procedure.

Thus, the present disclosed example can make the management apparatus to control the electronic apparatuses using the different communication protocols to revert by the single existing communication protocol.

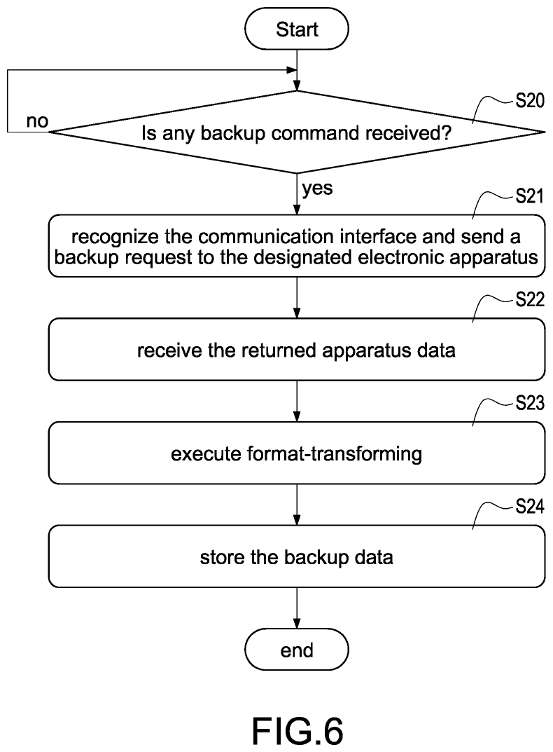

Please refer to FIG. 5 and FIG. 6 together. FIG. 6 is a flowchart of the backup procedure of the cross-protocol method for restoring apparatuses according to a second embodiment of the present disclosed example. Compare to the cross-protocol method for restoring apparatuses shown in FIG. 5, the cross-protocol method for restoring apparatuses shown in FIG. 6 further provides a backup function having the ability to automatically backup the apparatus data of the electronic apparatuses 41-44 operating normally for the restoring procedure of the electronic apparatus in the future. More specifically, the cross-protocol method for restoring apparatuses of this embodiment may comprises following steps before the execution of the restoring procedure.

Step S20: the controller 300 of the cross-protocol control apparatus 30 switches to a backup mode. Under the backup mode, the controller 300 may determine whether a backup command is received. The above backup command is to request to back up the configurations of at least one of the electronic apparatuses 41-44 (such as the electronic apparatus 41).

One of the exemplary embodiments, the above backup command is sent from the management apparatus 40.

One of the exemplary embodiments, the above backup command is generated by the user operating the human-machine interface 306 of the cross-protocol control apparatus 30, but this specific example is not intended to limit the scope of the present disclosed example.

If the controller 300 receives the backup command, the steps S21-S24 are performed for executing the backup procedure for the electronic apparatus 41. Otherwise, the controller performs the step S20 for continuously monitoring.

Step S21: during the execution of the backup procedure, the controller 300 recognizes the communication interface 302 connected to the electronic apparatus 41 (namely, the electronic apparatus designated by the backup command), generates a backup request, and uses the communication interface 302 to send the backup request to the designated electronic apparatus 41 based on the corresponding communication protocol.

One of the exemplary embodiments, the above backup request is to request the electronic apparatus 41 to provide the current configuration values of the operational parameters.

Step S22: the controller 300 receives the returned apparatus data from the electronic apparatus 41 by the communication interface 302. More specifically, the electronic apparatus 41 collects the current configuration values (namely, the apparatus data) of the operational parameters of the electronic apparatus 41 after receiving the backup request, and returns the apparatus data to the cross-protocol control apparatus 30.

Step S23: the controller 300 execute a process of saved-format-transforming on the received apparatus data for transforming the apparatus into the backup data compatible with a saved format.

The above saved format is a special design format provided by the present disclosed example, the saved format can be converted to the different format used by the different communication protocols in lossless, or the other formats used by the different communication protocols can be converted to the saved format in lossless. Thus, the cross-protocol backup could be implemented. Step S24: the controller 300 stores the backup data. The controller 300 may store the backup data in the storage 305, or store the backup data in outside apparatus (such as the management apparatus 40 or the cloud storage space), but this specific example is not intended to limit the scope of the present disclosed example.

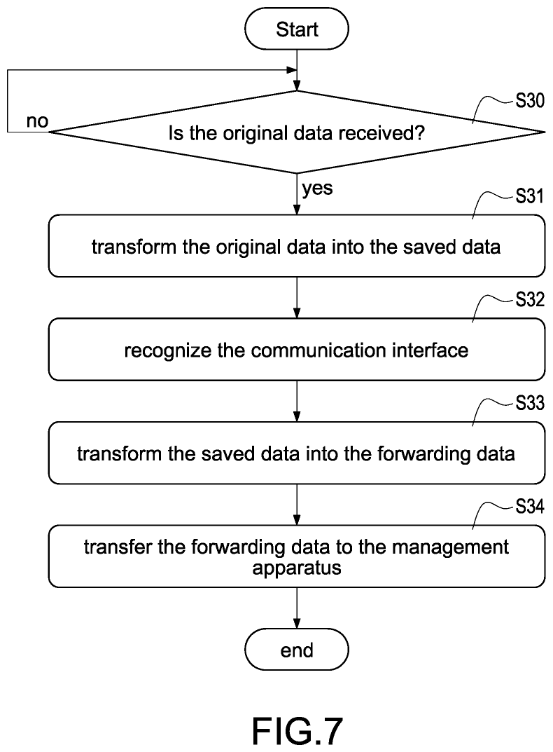

Please refer to FIG. 3 and FIG. 7 together. FIG. 7 is a flowchart of the forwarding procedure of the cross-protocol method for restoring apparatuses according to a third embodiment of the present disclosed example. Compare to the cross-protocol method for restoring apparatuses shown in FIG. 5, the cross-protocol method for restoring apparatuses shown in FIG. 7 further provides a forwarding function having the ability to automatically transform the data (having the format of the communication protocol used by the communication interface 301) sent from the management apparatus 40 into the data (having each format of the communication protocol used by each of the communication interfaces 302-304) readable by the electronic apparatus 41-44. Thus, the cross-protocol communication could be implemented. More specifically, the cross-protocol method for restoring apparatuses of this embodiment may further comprises following steps.

Step S30: the controller 300 switches to a forwarding mode. Under the forwarding mode, the controller 300 may detect whether original data (namely, the restoring data, the backup data, the apparatus data and the transferring data, or the restoring command, backup data and the other command) is received by any of the communication interfaces 301-304 from at least one of the management apparatus 40 and the electronic apparatuses 41-44. The above original data is matched with the format (hereinafter the original format for abbreviation) of the communication interface 301-304 used to receive data.

If the controller 300 receives the original data, such as the original data which the management apparatus 40 sends to the electronic apparatus 43, in other words, the electronic apparatus 43 is the destination), the steps S31-S34 are performed for the execution of the forwarding procedure. Otherwise, the controller 300 executes the step S30 again for continuously monitoring. Step S31: during the execution of the forwarding procedure, the controller 300 transforms the original data compatible with the original format into the saved data compatible with a saved format.

Step S32: the controller 300 recognizes the communication interfaces 303 and 304 connected to the electronic apparatus 43 (namely, the destination of the original data) designated by the saved data. Please be noted that when there are communication interfaces 303 and 304 simultaneously connected to the designated electronic apparatus 43, the controller 300 may select the communication interface with the better quality (such as selecting the communication interface 303) for communication. In another example, the original data may designate the communication interface (such as recording the MAC address or the network address of the communication interface 303) for communication, but this specific example is not intended to limit the scope of the present disclosed example.

Step S33: the controller 300 executes the process of forwarding-format-transforming on the saved data to transform the saved data with the saved format into the forwarding data with the forwarding format of the communication protocol used by the communication interface 303. Step S34: the controller 300 uses the corresponding communication protocol by the recognized communication interface 303 to transfer the forwarding data after format-transforming to the electronic apparatus 43.

Thus, the cross-protocol control apparatus of the present disclosed example can effectively provide the cross-protocol communication. Please be noted that, in another example, the electronic apparatus 41-44 may send data to the other electronic apparatuses 41-44 or the management apparatus 40 by the above means, but this specific example is not intended to limit the scope of the present disclosed example.

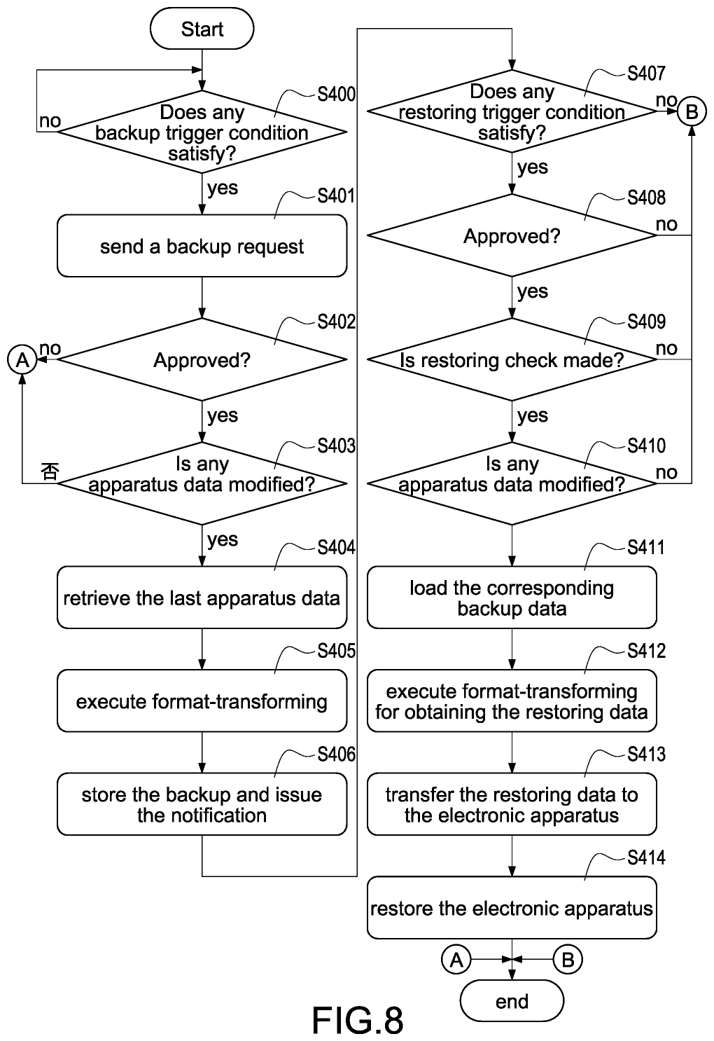

Please refer to FIG. 8, which is a flowchart of the cross-protocol method for restoring apparatuses according to a fourth embodiment of the present disclosed example. The cross-protocol method for restoring apparatuses of this embodiment comprises following steps.

Step S400: the controller 300 determines whether the default backup trigger condition is satisfied.

One of the exemplary embodiments, the backup trigger condition may comprise a designated time (such as 12 o′clock every day) coming, connecting to the electronic apparatus each time, receiving the backup command from the management apparatus 40 and/or receiving a backup operation by the human-machine interface 306, but this specific example is not intended to limit the scope of the present disclosed example.

If the controller 300 determines the backup trigger condition is fulfilled, performs the step S401 for starting to execute the backup procedure. Otherwise, the controller 300 performs the step S400 again for continuously monitoring.

Step S401: during the backup procedure, the controller 300 sends a backup request based on the backup trigger condition.

One of the exemplary embodiments, the backup trigger condition comprises designating at least one of the electronic apparatuses 41-44 and backup range (such as all or a part of operational parameters). Following description takes backing up all of the operational parameters of the electronic apparatuses 42, 43 for explanation.

The controller 300 recognizes the corresponding communication interfaces 302-303 based on the backup trigger condition, and sends the backup request of requesting all the operational parameters to the electronic apparatuses 42, 43.

The present disclosed example further provides a verification function having the ability to verify the requesting device and target device before backup for improving security.

More specifically, step S402: during the backup procedure, the verification module 307 retrieves the verification information and determines whether the apparatus passes the verification.

One of the exemplary embodiments, the verification module 307 executes the verification on the electronic apparatus 42, 43 which the user would like to back up for preventing from backing up the wrong apparatus. For example, the verification module 307 may transfer the verification information (such as identification information of the electronic apparatuses recorded in the backup request and/or passwords) by the communication interfaces 302, 303 to the electronic apparatuses 42, 43 for making the electronic apparatuses 42, 43 execute the verification by themselves based on the verification information (such as checking whether the identification information and/or the password is correct).

In another example, the verification module 307 may receive the apparatus data sent from the electronic apparatuses 42, 43 after approval through the communication interfaces 302,303, the electronic apparatuses 42, 43 receive the identification information and/or the password, and compare the data with the verification information for determining whether the electronic apparatuses 42, 43 are the eligible backup targets.

One of the exemplary embodiments, the verification module 307 is configured to verify the management apparatus 40 or the administrator requesting the backup, such as checking whether the management apparatus 40 or the administrator has the backup authority, or whether the password or license provided by the management apparatus or the administrator is correct.

If the verification module 307 determines that the verification information is approved, the step S403 is performed. If the verification module 307 determines that the verification information is not approved (fail to pass the verification), the verification module 307 issues an alarm and terminate the backup procedure.

The present disclosed example further provides a status-checking function having the ability to check whether the backup is suitable to be executed for preventing from the invalid backup or backup failure.

Step S403: the controller 300 determines the status of each of the electronic apparatuses 42, 43.

One of the exemplary embodiments, the controller 300 checks whether each of the electronic apparatuses 42, 43 is under a restorable status by the communication interfaces 302, 303, such as being idle or being under a status of any apparatus data being editing (the backup procedure may back up the old apparatus data in this status).

One of the exemplary embodiments, the controller 300 determines whether any apparatus data of each of the electronic apparatuses 42, 43 is modified, such as comparing the current apparatus data with the backup apparatus data corresponding to the backup data previously stored for determining whether any configuration of the electronic apparatuses 42, 43 is changed during this time period.

If the controller 300 determines that having to back up the electronic apparatuses 42, 43(such as the electronic apparatuses 42, 43 are under the restorable status or any configuration is modified), the step S404 is performed. Otherwise, the backup procedure is finished.

Step S404: during the backup procedure, the controller 300 retrieves the last (newest and current) apparatus data of the electronic apparatuses 42 and 43, such as sending a request to make each of the electronic apparatuses 42, 43 return the apparatus data.

Step S405: during executing the backup procedure, the controller 300 executes the process of saved-format-transforming on the received apparatus data for transforming the apparatus data into the backup data compatible with the saved format.

Step S406: during executing the backup procedure, the controller 300 stores the backup data to complete the execution of backup data this time, and issues the notification. Step S407: the controller 300 determines whether the default restoring trigger condition is satisfied.

One of the exemplary embodiments, the restoring trigger condition may comprise a designated time coming, connecting to the electronic apparatus each time, receiving the restoring command from the management apparatus 40 and/or receiving a restoring operation by the human-machine interface 306, but this specific example is not intended to limit the scope of the present disclosed example.

One of the exemplary embodiments, the restoring trigger condition comprises designating at least one of the electronic apparatuses 41-44 and restoring range (such as all or a part of operational parameters). Following description takes restoring all of the operational parameters of the electronic apparatuses 42, 43 for explanation.

If the controller determines that the restoring trigger condition is satisfied, the step S408 is performed for starting to execute the restoring procedure. Otherwise, the controller 300 performs the step S407 again for continuously monitoring.

The verification function of the present disclosed example may further execute the verification on the requesting device and target device before restoring for improving security.

Step S408: during the execution of the restoring procedure, the verification module 307 retrieves the verification information and determines whether the apparatus passes the verification.

The above execution of verification is the same or similar as the execution of verification of the step S402, the relevant description is omitted for brevity.

If the verification module 307 determines that the verification information is approved (such as receiving an approved notification form the electronic apparatuses 42, 43, the step S409 is performed. If the verification module 307 determines that the verification information is not approved (fail to pass the verification), the verification module 307 issues an alarm and terminate the restoring procedure. Please be noted that the process of verification of the steps 402 and S408 are not the necessary step in the present disclosed example. The steps may be omitted by the person skilled in the art of the present disclosed example if it is under the status of safe and secure.

The present disclosed example further provides a status-checking function having the ability to check whether the restoring is suitable to be executed for preventing the invalid restoring (such as the execution of useless restoring because the configurations are not modified) or restoring failure (such as an apparatus is under unrestorable status).

Step S409: the controller 300 checks the status of each of the electronic apparatuses 42, 43 which the user would like to restore, such as checking whether the electronic apparatuses 42, 43 is under the restorable status respectively by the communication interfaces 302, 303. If the controller 300 determines that the electronic apparatuses 42, 43 are under the restorable status, the step S410 is performed. Otherwise, the execution of the restoring procedure is terminated this time.

Step S410: the controller 300 retrieves the current apparatus data of the electronic apparatuses 42, 43, compares the current apparatus data with the backup apparatus data corresponding to the backup data for checking whether any configuration of the electronic apparatuses 42, 43 is changed.

If the controller 300 determines that any configuration (namely, the apparatus data) of the electronic apparatuses 42, 43 had been modified, the step S411 is performed. Otherwise, the execution of the restoring procedure is terminated.

Step S411: during the execution of the restoring procedure, the controller 300 retrieves the backup data of the electronic apparatuses 42, 43.

Step S412: during the execution of the restoring procedure, the controller 300 executes the process of forwarding-format-transforming on the backup data for transforming the retrieved backup data into the restoring data compatible with the forwarding format of the communication protocol used by the communication interfaces 302, 303.

Step S413: during the execution of the restoring procedure, the controller 300 uses the corresponding communication protocol to transfer the restoring data to the electronic apparatus 42, 43 by the communication interface 302.

Step S414: during the execution of the restoring procedure, the electronic apparatuses 42, 43 respectively restore their configurations based on the received restoring data.

Thus, the present disclosed example can effectively implement backing up and restoring the apparatuses in the cross-protocol.

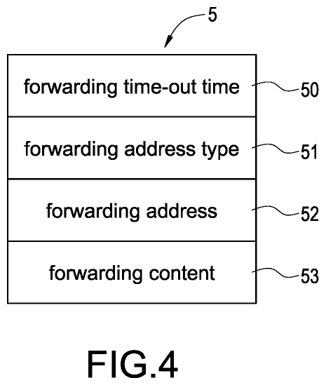

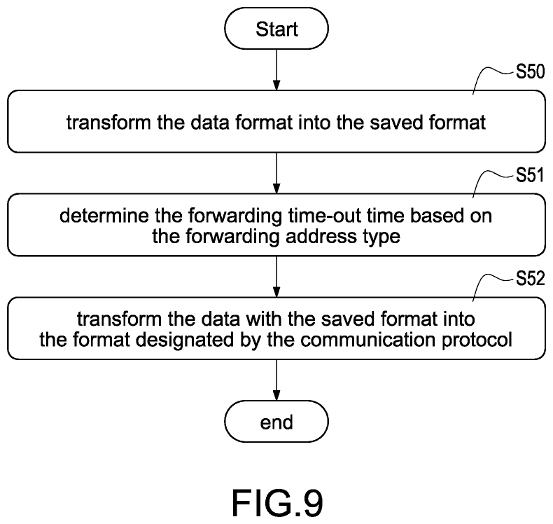

Please refer to FIG. 4 and FIG. 9 together. FIG. 4 is a schematic view of the forwarding format according to an implement aspect of the present disclosed example, and FIG. 9 is a flowchart of the process of format-transforming of the cross-protocol method for restoring apparatuses according to a fifth embodiment of the present disclosed example.

The present disclosed example provides one saved format compatible with the formats of the communication protocols. As shown in FIG. 4, the saved format 5 mainly comprises four fields: forwarding time-out time 50, forwarding address type 51, forwarding address 52 and forwarding content 53.

The forwarding address type is used to describe the communication protocol used by the communication interface connected to the forwarding destination. The forwarding time-out time is used to configure the allowable upper limit of waiting time for forwarding. The forwarding address is used to describe the address of the forwarding destination in the address format compatible with the communication interface. The forwarding content is used to record the content of the data to forward.

The process of format-transforming of the cross-protocol method for restoring apparatuses of the embodiment comprises following steps.

Step S50: the controller 300 transforms the format of the received original data (such as the data received from the management apparatus 40 or the electronic apparatuses 41-44) into the saved format, such as transforming the original data compatible with the original format into the saved data compatible with the saved format.

Step S51: the controller 300 determines the forwarding time-out time based on the forwarding address type of the original data.

More specifically, the allowable forwarding time-out time is different if the different communication protocol (the forwarding address type) is used. The present disclosed example can effectively reduce the probability of transmission failure by simultaneously adjusting the forwarding time-out time to be suitable when transforming the format.

Step S52: the controller 300 transforms the saved data form the saved format into the forwarding format corresponding to the forwarding address type. Namely, the saved data with the saved format is transformed into the forwarding data with the forwarding format.

Thus, the present disclosed example can implement the format-transforming between the formats of the different communication protocols.

TABLE 1
REQUEST

| | |
|---|---|
| forwarding time-out time | 0x0B |
| (Hi-byte) | |
| forwarding time-out time | 0xB8 |
| (Low-byte) | |
| forwarding address type | 0x00 |
| (MODBUS) | |
| forwarding address | 0x01 |
| (Station number) | |
| forwarding content 0 | 0x03 |
| (Function code-loading device) | |
| forwarding content 1 | 0x20 |
| (Device address) | |
| forwarding content 2 | 0x00 |
| (Device address) | |
| forwarding content 3 | 0x00 |
| (Loading number) | |
| forwarding content 4 | 0x01 |
| (Loading number) | |

TABLE 2
RESPONSE

| | |
|---|---|
| forwarding address type | 0x00 |
| (MODBUS) | |
| forwarding address | 0x01 |
| (Station number) | |
| return content 0 | 0x03 |
| (Function code-loading device) | |
| return content 1 | 0x02 |
| (Length of response data) | |
| return content 2 | 0x12 |
| (Response data) | |
| return content 3 | 0x34 |
| (Response data) | |

Next, following is an exemplary description of the format-transforming of the present disclosed example. In the Table 1 and Table 2, the example is to transform the saved format into the MODBUS format. Table 1 shows the request data with the saved format, and Table 2 shows the response data with the MODBUS format.

It can be seen from Table 1 and Table 2, the saved format comprises all of the fields of the MODBUS format, so the conversion from the saved format to the MODBUS format can be implemented. Moreover, the conversion from the MODBUS format to the saved format can also be implemented, only the corresponding time-out time is needed to be configured. More specifically, the combination of the forwarding contents 0 to 4 of Table 1 corresponds to the combination of the return contents 0 to 3 of Table 2, the length of the field of each forwarding content 0 to 4 may be the same as/different from the length of the field of each return contents 0 to 3.

The above example takes using the station number (1) to address for example. Moreover, because the serial communication is slow, the longer timeout time (3000 ms) is configured.

TABLE 3
REQUEST

| | |
|---|---|
| forwarding time-out time | 0x01 |
| (Hi-byte) | |
| forwarding time-out time | 0xF4 |
| (Low-byte) | |
| forwarding address type | 0x01 |
| (MODBUS TCP) | |
| forwarding address 1 | 0xC0 |
| (IP address) | |
| forwarding address 2 | 0xA8 |
| (IP address) | |
| forwarding address 3 | 0x01 |
| (IP address) | |
| forwarding address 4 | 0x05 |
| (IP address) | |
| forwarding address 5 | 0x01 |
| (Station number) | |
| forwarding content 0 | 0x03 |
| (Function code-loading device) | |
| forwarding content 1 | 0x20 |
| (Device address) | |
| forwarding content 2 | 0x00 |
| (Device address) | |
| forwarding content 3 | 0x00 |
| (Loading number) | |
| forwarding content 4 | 0x01 |
| (Loading number) | |

TABLE 4
RESPONSE

| | |
|---|---|
| forwarding address type | 0x01 |
| (MODBUS TCP) | |
| forwarding address 1 | 0xC0 |
| (IP address) | |
| forwarding address 2 | 0xA8 |
| (IP address) | |
| forwarding address 3 | 0x01 |
| (IP address) | |
| forwarding address 4 | 0x05 |
| (IP address) | |
| forwarding address 5 | 0x01 |
| (Station number) | |
| return content 0 | 0x03 |
| (Function code-loading device) | |
| return content 1 | 0x02 |
| (Length of response data) | |
| return content 2 | 0x12 |
| (Response data) | |
| return content 3 | 0x34 |
| (Response data) | |

In the table 3 and table 4, the example is to transform the saved format into the MODBUS TCP format. Table 3 shows the request data with the saved format, and Table 4 shows the response data with the MODBUS TCP format.

It can be seen from Table 3 and Table 4, the saved format comprises all of the fields of the MODBUS TCP format, so the conversion from the saved format to the MODBUS format can be implemented. Moreover, the conversion from the MODBUS TCP format to the saved format can also be implemented, only the corresponding time-out time is needed to be configured. More specifically, the combination of the forwarding contents 0 to 4 of Table 3 corresponds to the combination of the return contents 0 to 3 of Table 4, the length of the field of each forwarding content 0 to 4 may be the same as/different from the length of the field of each return contents 0 to 3.

The above example takes using the network address (IP, such as 192.168.1.5) to address for example. Moreover, because the Ethernet is faster, the shorter timeout time (500 ms) is configured.

TABLE 5
REQUEST

| | |
|---|---|
| forwarding time-out time | 0x01 |
| (Hi-byte) | |
| forwarding time-out time | 0xF4 |
| (low-byte) | |
| forwarding address type | 0x02 |
| (CANopen) | |
| forwarding address 1 | 0x03 |
| (NodeID) | |
| forwarding content 0 | 0x40 |
| (Service code-Read) | |
| forwarding content 1 | 0x03 |
| (SubIndex) | |
| forwarding content 2 | 0x00 |
| (device address) | |
| forwarding content 3 | 0x10 |
| (Index Hi-byte) | |
| forwarding content 4 | 0x00 |
| (Index Low-byte) | |

TABLE 6
RESPONSE

| | |
|---|---|
| forwarding address type | 0x02 |
| (CANopen) | |
| forwarding address | 0x03 |
| (NodeID) | |
| return content 0 | 0x43 |
| (Service code) | |
| return content 1 | 0x07 |
| (Data len.) | |
| return content 2 | 0x00 |
| (SubIndex) | |
| return content 3 | 0x01 |
| (Response Code) | |
| return content 4 | 0x00 |
| (Data byte 0) | |
| return content 5 | 0x00 |
| (Data byte 1) | |
| return content 6 | 0x01 |
| (Data byte 2) | |
| return content 7 | 0xDD |
| (Data byte 3) | |

In the Table 5 and Table 6, the example is to transform the saved format into the CANopen format. Table 5 shows the request data with the saved format, and Table 6 shows the response data with the CANopen format.

It can be seen from Table 5 and Table 6, the saved format comprises all of the fields of the CANopen format, so the conversion from the saved format to the CANopen format can be implemented. Moreover, the conversion from the CANopen format to the saved format can also be implemented, only the corresponding time-out time is needed to be configured. More specifically, the combination of the forwarding contents 0 to 4 of Table 5 corresponds to the combination of the return contents 0 to 7 of Table 6, the length of the field of each forwarding content 0 to 4 may be the same as/different from the length of the field of each return contents 0 to 7.

The above example takes using the node ID (1) to address for example. Moreover, because the CANopen is faster, the shorter timeout time (500 ms) is configured.

Thus, the present disclosed example can implement the communication and backup in cross-protocol.

The above-mentioned are only preferred specific examples in the present disclosed example, and are not thence restrictive to the scope of claims of the present disclosed example. Therefore, those who apply equivalent changes incorporating contents from the present disclosed example are included in the scope of this application, as stated herein.

What is claimed is:

1. A cross-protocol method for restoring apparatuses applied to a cross-protocol control apparatus, the method comprising following steps:
a) a controller of the cross-protocol control apparatus connecting to a management apparatus and a plurality of electronic apparatuses by a plurality of communication interfaces of the cross-protocol control apparatus, wherein the communication interfaces are respectively configured to use different communication protocols;
b) executing a restoring procedure when receiving a restoring command for at least one of the electronic apparatuses from the management apparatus;
c) during the restoring procedure, recognizing the communication interface connected to the electronic apparatus and retrieving backup data for the electronic apparatus;
d) during the restoring procedure, executing a process of forwarding-format-transforming on the backup data for transforming the backup data into restoring data compatible with the communication protocol used by the communication interface being recognized; and
e) during the restoring procedure, transferring the restoring data to the electronic apparatus for making the electronic apparatus restore configurations by itself based on the restoring data.

2. The cross-protocol method for restoring apparatuses according to claim 1, further comprising following steps:
f1) transforming original data into saved data compatible with a saved format when receiving the original data compatible with an original format from at least one of the management apparatus and the electronic apparatuses, wherein the original data is configured to designate another of the management apparatus and the electronic apparatuses as a destination;
f2) recognizing the communication interface connected to the another of the management apparatus and the electronic apparatuses;
f3) executing the process of forwarding-format-transforming on the saved data to transform the saved data compatible with the saved format into forwarding data compatible with a forwarding format for the communication protocol used by the communication interface; and
f4) transferring the forwarding data to the another of the management apparatus and the electronic apparatuses by the communication interface being recognized based on the corresponding communication protocol.

3. The cross-protocol method for restoring apparatuses according to claim 1, wherein the process of forwarding-format-transforming comprises following steps:
g1) transforming original data into saved data compatible with a saved format;
g2) determining a forwarding time-out time based on a forwarding address type of the original data, wherein the forwarding address type is used to describe the communication protocol used by the communication interface connected to a forwarding destination, the forwarding time-out time is used to configure an allowable upper limit of waiting time for forwarding; and
g3) transforming the saved data compatible with the saved format into forwarding data compatible with a forwarding format of the communication protocol, wherein the forwarding format is described by the forwarding address type of the original data.

4. The cross-protocol method for restoring apparatuses according to claim 3, wherein the saved format comprises following fields: the forwarding address type, the forwarding time-out time, a forwarding address, and a forwarding content; the forwarding address is used to describe an address of the communication interface of the forwarding destination, the forwarding content is used to record content of data to be forwarded.

5. The cross-protocol method for restoring apparatuses according to claim 1, further comprising a step h) executing the restoring procedure when a restoring trigger condition is satisfied, wherein the restoring trigger condition comprises a designated time coming, connecting to the electronic apparatus each time or receiving a restoring operation by a human-machine interface of the cross-protocol control apparatus.

6. The cross-protocol method for restoring apparatuses according to claim 1, further comprising following steps performed before the step c):
h1) during the restoring procedure, retrieving verification information; and
h2) transferring the verification information to the electronic apparatus by the communication interface for making the electronic apparatus verify the verification information;
the step c) is performed after receiving a notification of approval from the electronic apparatus.

7. The cross-protocol method for restoring apparatuses according to claim 1, further comprising following steps performed before the step c):
i1) checking whether the electronic apparatus is under a restorable status by the communication interface;
i2) retrieving current apparatus data of the electronic apparatus if the electronic apparatus is under the restorable status; and
i3) comparing the current apparatus data with backup apparatus data corresponding to the backup data for determining whether any configuration of the electronic apparatus is modified;
the step c) is performed after determining that at least one of the configurations of the electronic apparatus is modified.

8. The cross-protocol method for restoring apparatuses according to claim 1, further comprising following steps performed before the step b):
j1) executing a backup procedure when the controller receives a backup command for at least one of the electronic apparatuses;
j2) during the backup procedure, recognizing the communication interface connected to the electronic apparatus, and sending a backup request to the electronic apparatus by the communication interface being recognized;
j3) during the backup procedure, receiving an apparatus data from the electronic apparatus;
j4) during the backup procedure, executing a process of saved-format-transforming on the apparatus data for transforming the apparatus data into the backup data compatible with a saved format; and
j5) storing the backup data in a storage of the cross-protocol control apparatus.

9. The cross-protocol method for restoring apparatuses according to claim 8, further comprising following steps performed before the step j3):
k1) during the backup procedure, retrieving verification information; and
k2) transferring the verification information to the electronic apparatus by the communication interface for making the electronic apparatus verify the verification information;
the step j3) is performed to receive the apparatus data sent by the electronic apparatus after the verification information is approved.

10. The cross-protocol method for restoring apparatuses according to claim 8, further comprising following steps performed before the step j3) and after the step j2):
l1) checking whether the electronic apparatus is under a restorable status by the communication interface;
l2) retrieving current apparatus data of the electronic apparatus if the electronic apparatus is under the restorable status; and
l3) comparing the current apparatus data with backup apparatus data corresponding to the backup data for determining whether any configuration of the electronic apparatus is modified;
the step j2) is performed to return the current apparatus data if at least one of the configurations of the electronic apparatus is modified.

11. A cross-protocol control apparatus with apparatus-restoring function, comprising:
a plurality of communication interfaces respectively connected to a management apparatus and a plurality of electronic apparatuses, the communication interfaces respective use the different communication protocols;
a storage used to store apparatus data of each electronic apparatus; and
a controller electrically connected to the communication interfaces and the storage; the controller is configured to execute a restoring procedure when receiving a restoring command for at least one of the electronic apparatuses from the management apparatus;
wherein during the restoring procedure, the communication interface connected to the electronic apparatus is recognized, the backup data of the electronic apparatus is loaded, a process of forwarding-format-transforming is executed on the backup data for transforming the backup data into restoring data compatible with the communication protocol used by the communication interface being recognized, and the restoring data is transferred to the electronic apparatus for making the electronic apparatus restore configurations by itself based on the restoring data.

12. The cross-protocol control apparatus with apparatus-restoring function according to claim 11, wherein the controller is configured to transform original data into saved data compatible with a saved format when receiving the original data compatible with an original format from at least one of the management apparatus and the electronic apparatuses, the original data is configured to designate another of the management apparatus and the electronic apparatuses as a destination, the controller is further configured to recognize the communication interface connected to the another of the management apparatus and the electronic apparatuses, execute the process of forwarding-format-transforming on the saved data to transform the saved data compatible with the saved format into forwarding data compatible with a forwarding format for the communication protocol used by the communication interface, and transfer the forwarding data to the another of the management apparatus and the electronic apparatuses by the communication interface being recognized based on the corresponding communication protocol.

13. The cross-protocol control apparatus with apparatus-restoring function according to claim 11, wherein during the process of forwarding-format-transforming, the controller is configured to transform original data into saved data compatible with a saved format, determine a forwarding time-out time based on a forwarding address type of the original data, and transform the saved data compatible with the saved format into forwarding data compatible with a forwarding format of the communication protocol, wherein the forwarding format is described by the forwarding address type, the forwarding address type is used to describe the communication protocol used by the communication interface connected to a forwarding destination, the forwarding time-out time is used to configure an allowable upper limit of waiting time for forwarding.

14. The cross-protocol control apparatus with apparatus-restoring function according to claim 13, wherein the saved format comprises following fields: the forwarding address type, the forwarding time-out time, a forwarding address, and a forwarding content; the forwarding address is used to describe an address of the communication interface of the forwarding destination, the forwarding content is used to record content of data to be forwarded.

15. The cross-protocol control apparatus with apparatus-restoring function according to claim 11, further comprising a human-machine interface electrically connected to the controller;
wherein the controller is configured to execute the restoring procedure when a restoring trigger condition is satisfied, wherein the restoring trigger condition comprises a designated time coming, connecting to the electronic apparatus each time or receiving a restoring operation by the human-machine interface of the cross-protocol control apparatus.

16. The cross-protocol control apparatus with apparatus-restoring function according to claim 11, further comprising a verification module electrically connected to the controller; wherein during the restoring procedure, the verification module retrieves verification information, and transfers the verification information to the electronic apparatus by the communication interface for making the electronic apparatus verify on the verification information;
wherein the controller is configured to execute the restoring procedure after receiving a notification of approval from the electronic apparatus.

17. The cross-protocol control apparatus with apparatus-restoring function according to claim 11, wherein the controller is configured to check whether the electronic apparatus is under a restorable status by the communication interface, retrieve current apparatus data of the electronic apparatus if the electronic apparatus is under the restorable status, and compare the current apparatus data with backup apparatus data corresponding to the backup data for determining whether any configuration of the electronic apparatus is modified;
wherein the controller is further configured to execute the restoring procedure after determining that at least one of configurations of the electronic apparatus is modified.

18. The cross-protocol control apparatus with apparatus-restoring function according to claim 11, wherein the controller is configured to execute a backup procedure when receiving a backup command for at least one of the electronic apparatuses;
wherein during the backup procedure, the controller is configured to recognize the communication interface connected to the electronic apparatus, send a backup request to the electronic apparatus by the communication interface being recognized, and receive an apparatus data from the electronic apparatus;
wherein during the backup procedure, a process of saved-format-transforming is executed on the apparatus data for transforming the apparatus into the backup data compatible with a saved format, and the backup data is stored in a storage of the cross-protocol control apparatus.

19. The cross-protocol control apparatus with apparatus-restoring function according to claim 11, further comprising a verification module, wherein during the backup procedure, the verification module is configured to retrieve verification information, and transfer the verification information to the electronic apparatus by the communication interface for making the electronic apparatus verify the verification information;
wherein, the controller is configured to receive the apparatus data sent from the electronic apparatus after the verification information is approved.

20. The cross-protocol control apparatus with apparatus-restoring function according to claim 11, wherein the controller is configured to check whether the electronic apparatus is under a restorable status by the communication interface, retrieve current apparatus data of the electronic apparatus if the electronic apparatus is under the restorable status, and compare the current apparatus data with backup apparatus data corresponding to the backup data for determining whether any configuration of the electronic apparatus is modified;
wherein the controller is configured to receive the current apparatus data sent from the electronic apparatus, the current apparatus data is sent when the electronic apparatus determines that at least one of the configurations is modified.
